(19) United States
(12) Patent Application Publication
(10) Pub. No.: US 2003/0031513 A1
(43) Pub. Date: Feb. 13, 2003

(54) Apparatus and method for removing contaminated surface soil

(75) Inventor: Joseph Messana, Dyer, IN (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Jet Vac, Inc., Chicago, IL

(21) Appl. No.: 09/925,768

(22) Filed: Aug. 9, 2001

(51) Int. Cl. B09C 1/08; B09C 1/10

(52) U.S. Cl. 405/128.5

(57) ABSTRACT

A machine for continuously removing and packaging contaminated surface soil from sites, such as nuclear test areas, as the machine moves along a path of travel. The machine includes an auger-type scarfing unit for removing an upper layer of surface soil and directing the soil airborne into a chamber substantially enclosed to the outside environment, a soil separation and first bagging station including a cyclone generator for pneumatically receiving an air stream of soil removed by the scarfing unit and separating soil from the air stream for containment in bags which are periodically discarded from the machine, a filter and second bagging station for filtering remaining particulate matter from the air stream for containment in disposable bags, and a final filter station for removing substantially all remaining particulate matter from the air stream prior to discharge to the environment. The auger unit closely follows the contour of the land and is adjustable for removing predetermined relatively shallow depths of soil so as to eliminate unnecessary soil removal and prevent tainting previously uncontaminated soil.

### FIELD OF THE INVENTION

The present invention relates generally to an apparatus and method for removing contaminated surface soil from the ground, and more particularly, to an apparatus and method particularly adapted for removing radioactive plutonium contaminated soil from desert atomic test sites.

### BACKGROUND OF THE INVENTION

Surface soil can be contaminated in many ways that is dangerous to future usage of the land or nearby inhabitants. Contamination can occur through the release of toxic chemicals, radioactive materials, and other environmentally dangerous substances. In certain instances the contamination may be limited to a specific contained area that can be corrected conventionally through excavation and removal of the affected area. Other contaminants can affect large surface areas that are difficult to ever economically correct.

Atomic test sites, for example, can contaminate many square miles of surface soil making it unsafe for subsequent habitation, development, or use. Conventional means for removing the contaminated soil is highly impractical and uneconomical. When road graders, bull dozers, or like excavation equipment are used to clear the land, such large amounts of soil are excavated or stripped away that it cannot be practically removed from the site or decontaminated. Moreover, the terrain and environment is seriously altered and damaged. Scraping the land with conventional excavation equipment generally removes all top soil and most contour, leaving the land with a sterile, environmentally unpleasant appearance. Moreover, since plutonium contamination from nuclear testing typically affects less than an inch of the topsoil, conventional excavation means commonly remove excessive amounts of soil. Cross-contamination of otherwise unaffected areas also can result by reason of blowing sand and dirt that occurs during excavation and packaging or loading soil in dry desert areas. Hence, nuclear test sites in the desert have remained contaminated for many years after nuclear testing has ceased, notwithstanding the increasing desire to reclaim and develop the land.

### OBJECTS AND SUMMARY OF THE INVENTION

It is an object of the present invention to provide an apparatus and method for more efficiently removing contaminated surface soil for disposal and/or decontamination, and more particularly, to an apparatus and method particularly adapted for use on large contaminated areas, such as desert nuclear test sites.

Another object is to provide an apparatus and method as characterized above which can be used without adversely affecting the contour of the land. A related object is to provide such an apparatus and method that is operable for closely following the contour of the affected surface area so as to minimize unnecessary soil removal.

Yet another object is to provide an apparatus and method of the above kind which is adapted for removing selective predetermined shallow depths of soil corresponding substantially to the depth of contamination so as to eliminate excessive and unnecessary soil removal, typical of the prior art, and the tainting of previously uncontaminated soil.

A further object is to provide an apparatus and method of the foregoing type which removes contaminated soil without discharge into the environment and blowing and cross-contamination onto otherwise unaffected surface areas.

Another object is to provide such an apparatus and method that is adapted to automatically bag and contain the removed contaminated soil for easy transport from the site for separation of contaminants or disposal.

Still a further object is to provide an apparatus and method of the above kind that is adapted to systematically unload bags of contaminated material as they are filled so as to enable the soil removal operation to be carried out on a continuous and uninterrupted basis. A related object is to provide an apparatus and method which facilitates reliable unloading of bags of contaminated soil without bag breakage or bursting as the apparatus continues in a forward operating movement.

Other objects and advantages of the invention will become apparent upon reading the following detailed description and upon reference to the drawings, in which:

### BRIEF DESCRIPTION OF THE DRAWINGS

FIG. 1 is a side elevational view of an illustrative contaminated soil removal machine embodying the present invention;

FIG. 2 is a perspective of the machine shown in FIG. 1, depicting the underside thereof;

FIG. 3 is a fragmentary perspective of the illustrated machine, particularly showing the soil removal station and the soil separation and first bagging station of the machine;

FIG. 4 is a perspective of the soil removal station, depicting the underside thereof;

FIG. 5 is vertical section of the soil removal station, taken in the plane of line 5-5 in FIG. 4;

FIG. 6 is a partially diagrammatic depiction of the cyclone generator of the soil separation and first bagger station and the downstream filter and second bagging station of the illustrated machine;

FIG. 7 is a top view of the filter and second bagging station taken in the plane of line 7-7 in FIG. 6;

FIG. 8 is an enlarged fragmentary section of one of the filters of the filter and second bagging station, taken in the plane of line 8-8 in FIG. 7.

FIG. 9 is a side elevational view of a soil removal machine, similar to that shown in FIG. 1, with an alternative embodiment of a soil removal station; and

FIG. 10 is an enlarged perspective of the soil removal station of the machine shown in FIG. 9.

While the invention is susceptible of various modifications and alternative constructions, a certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention. Hence, while the invention will be described in connection with an apparatus and method having particular utility for removing radioactive contaminated surface soil from desert nuclear test sites, it will be understood that the invention is similarly applicable to the efficient and safe removal of any contaminated surface soils.

### DETAILED DESCRIPTION OF THE PREFERRED EMBODIMENTS

Referring now more particularly to the drawings, there is shown an illustrative contaminated soil removal machine 10 embodying the present invention operable for continuously removing and processing contaminated surface soil from affected areas as the machine is driven in a forward direction. The illustrative machine 10 includes a self-propelled forward cab unit 11 and a rearwardly trailing soil removal and processing unit 12. The cab unit 11 in this case is a truck cab, powered by a conventional diesel or gasoline engine, which is removably coupled to the soil removal and processing unit 12 by appropriate hitch couplings. It will be understood that alternatively the cab unit 11 could be an integral part of the soil removal and processing unit 12. The cab unit 11 and soil removal and processing unit 12 in this case each are supported by pairs of oversized, balloon type all terrain tires 13, 14, respectively, which provide stable support for the machine in steeply contoured and varied terrains and necessary traction in sand or soft soil conditions.

In accordance with the invention, as an incident to forward movement of the machine, the soil processing unit is adapted to continuously remove a predetermined relatively shallow layer of soil, corresponding substantially to the depth of contamination, while closely following the contour of the land and without cross-contaminating unaffected soil, so as to permit more economical removal and decontamination of the soil while minimizing altercation and damage to the environment. To this end, the illustrated soil removal and processing unit 12 includes a self-contained power station 15, a rock and vegetation removal station 16, a soil removal station 18, a soil separation and first bagging station 19, a filtration and second bagging station 20, and a final filter station 21. As the cab unit 11 pulls the soil removal and processing unit 12 in a forward direction of travel, the machine is operable for removing and packaging the contaminated surface soil on a continuous and substantially uninterrupted basis for subsequent easy removal from the site.

For powering the various operating stations of the soil removal and processing unit 12, the power station 15 includes a self-contained power generating means, preferably is in the form of a diesel or gasoline powered engine mounted on a main frame 22 of the unit. The engine in this instance powers a plurality of conventional hydraulic drive units located at various of the operating stations for effecting the necessary operation and processing at the respective station, as will become apparent.

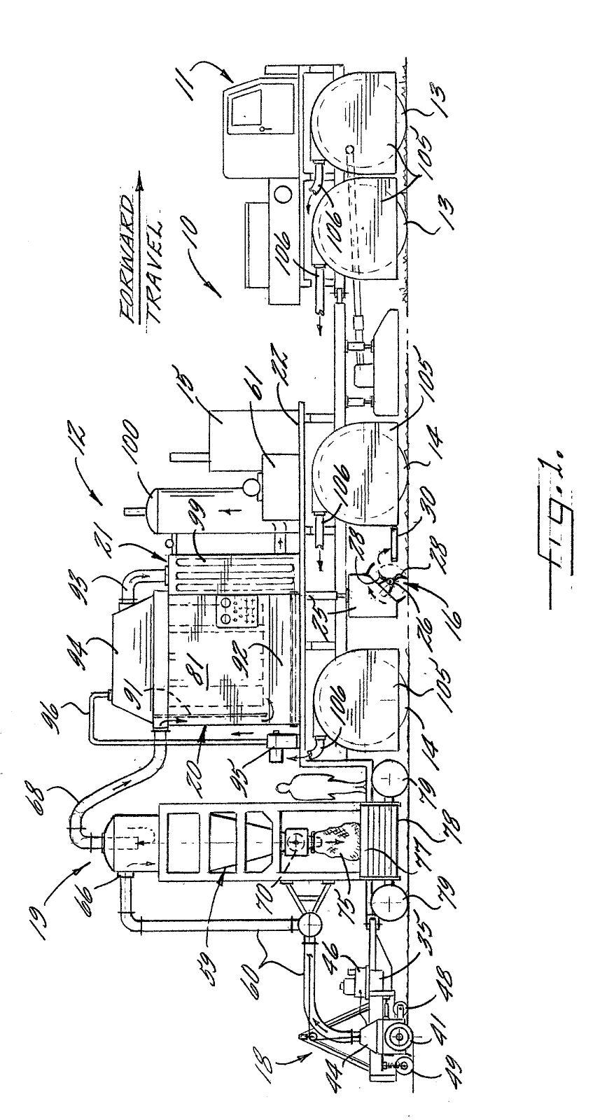

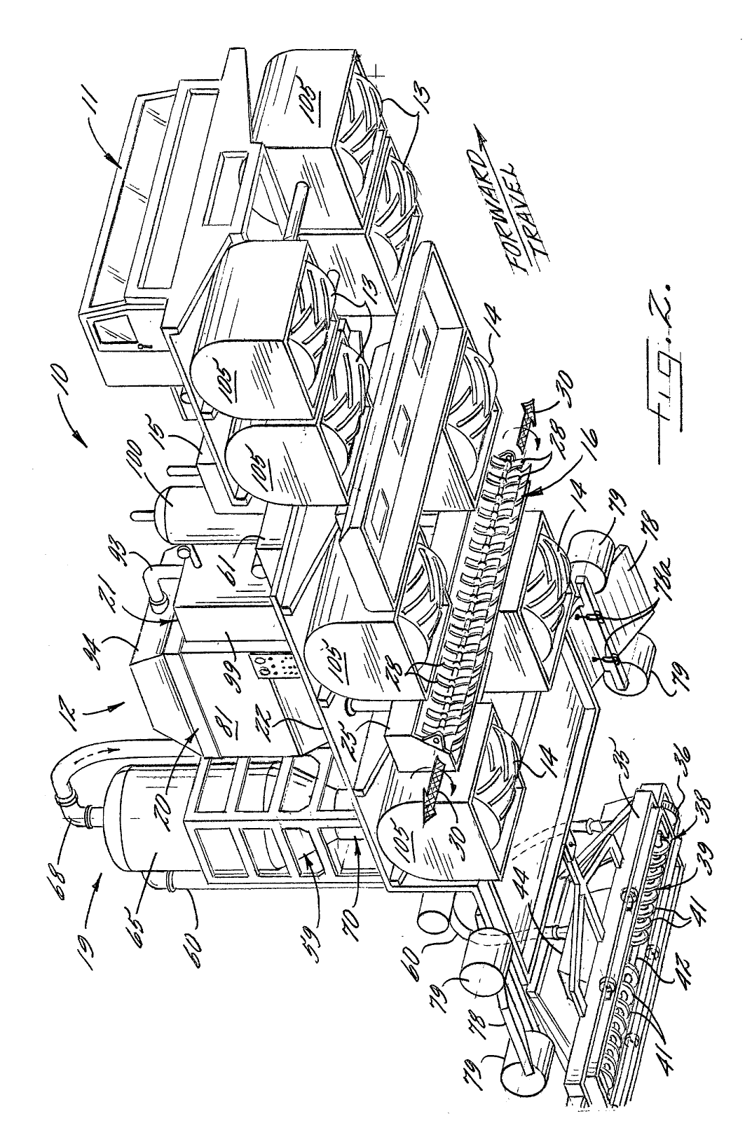

For removing rocks and vegetation from the surface of the soil in order to condition the soil for subsequent removal and processing, the rock and vegetation removal station 16 is located forwardly of the soil removal station 18 intermediate the pairs of support wheels 14. The rock and vegetation removal station 16 includes a housing 25 supported in depending relation from the underside of the main frame 22 and extending transversely across the width of the machine in surrounding relation to a rear and upper side of a power driven ground-engaging pronged shaft 26. The pronged shaft 26 in this instance includes a plurality of radially extending and curved fingers 28 in longitudinally spaced relation along the shaft 26 designed to engage the ground as an incident to rotation of the shaft in the clockwise direction, as viewed in FIGS. 1 and 2, dislodge and remove surface vegetation, and carry rocks and stones between the fingers 28 in a rearward and upward lifting direction. For this purpose, the fingers 28 curve radially outwardly in the direction of rotation to facilitate cradling and lifting of the rocks. It will be understood that other conventional types of de-rocker equipment could alternatively be used. To drive the pronged operating shaft 26, the end of the shaft carries has an appropriate drive sprocket which in turn is chain driven from a hydraulic drive unit for the station in a conventional manner.

For dislodging contaminated soil from the rocks and vegetation removed by the pronged shaft 26 and depositing removed rocks and vegetation to a side of the machine that has been previously worked by the machine, a screen conveyor 30 is disposed in parallel relation forwardly of the pronged shaft 26 for receiving vegetation and rocks lifted by the pronged shaft 26. The screen conveyor 30 comprises a continuous moving screen disposed about appropriate drive sprockets and support rolls and driven by a hydraulic drive for the station. It will be seen that as the pronged shaft fingers 28 engage, lift and deposit vegetation and rocks onto the screen, the tumbling action will loosen and dislodge the contaminated soil allowing it to drop through the screen and under the machine for subsequent removal by the soil removal station 18. Further soil dislodged during conveyance by the screen conveyor 30 similarly will fall through the screen and beneath the machine. The screen conveyor 30 preferably extends outwardly beyond both sides of the machine and can be selectively operated in either direction to enable conveyance of vegetation and rocks onto the surface area at the side of the machine that has previously been worked by the machine. Alternatively, it will be understood that in lieu of the screen conveyor 30, a containment bin may be provided forwardly of the pronged shaft 26 for receiving and containing removed vegetation and rocks for removal from the site.

In accordance with an important aspect of the invention, the soil removal station 18 includes one or more soil scarfing units that are adapted to closely follow the contour of the land to dislodge and remove a predetermined relatively shallow depth of contaminated soil and to impel the removed soil airborne into a chamber closed to the outside environment for subsequent direction and processing. In the illustrated embodiment, the soil removal station 18 is an independent unit having a metal framework 35 releasably connected for towing movement behind the soil separating and first bagging station 19. The frame 25 in this instance is supported for rolling movement by rearwardly disposed wheels 36.

For engaging and removing a predetermined relatively shallow depth of soil, corresponding substantially to the depth of contamination, as the machine is moved in a forward direction, a scarfing unit 38 having a rotatably driven auger 39 is supported for floating movement relative to the frame 35 between the wheels 36. The auger 39, which may extend substantially the width of the machine, is mounted within a downwardly opening housing 40. The illustrated auger 39 has scarfing blades 41 in the form of oppositely directed auger blades at opposite ends of a common auger shaft 42 which extend below the lower perimeter of the housing 40. The scarfing blades 41 are designed such that upon rotary movement of the shaft 42 a predetermined shallow depth of soil is engaged by the blades 41, moved laterally inwardly from opposite ends of the auger 39 to a central location of the housing 40, and then impelled upwardly into a central chamber 44 of the housing 40 above the auger blades 41 that is closed from the outside environment. In this regard, the auger-type scarfing blades 41 function much like a snow blower, namely by engaging and forcing a predetermined layer of surface material in an inward direction and then upwardly into the overhead chamber 44. For enclosing the rear side of the auger housing 40 to prevent the escape of dust and dirt into the environment during the soil removal operation, a flexible wiper 45 is mounted in depending fashion from a rear wall of the housing 40 for movement in sweeping fashion along the ground as the machine proceeds in a forward direction. To rotatably drive the auger shaft 42 a hydraulic drive unit 46 for the station is mounted on the frame 35 forwardly of the auger housing 40.

For permitting floating movement of the auger 39 during forward operating movement of the machine in order to accommodate changes in contour of the terrain, the auger 39 is supported for relative pivotal movement with respect to the frame 35 by pairs of brackets 47 extending forwardly between the auger housing 40 and the frame 35. To guide movement of the auger 39 along the ground and to accommodate its floating movement along the terrain, the auger housing 40 is supported by forward rollers 48 disposed at a predetermined distance above the lower perimeter of the auger scarfing blades 41 and by rearward shock mounted wheels 49 having a lower perimeter slightly below the lower perimeter of the scarfing blades 41, but being movable relative to their supports under the influence of biasing springs 50 to accommodate shock and regular surface terrain.

For selectively setting the soil removal depth of the auger 39, the auger housing 40 in this case is suspended by lift cables 51 that in turn are trained about pulleys 52 suspended from an upstanding framework 54, and an appropriate take-up mechanism driven by a hydraulic drive unit is operable for drawing in and releasing the lift cables, and thereby, vertically positioning the location and cutting depth of the auger 39. Preferably, the auger 39 is adjusted to remove a predetermined shallow depth of soil, such as between about one and three inches. Alternatively, it will be appreciated that other forms of auger cutting depth adjustment could be provided, such as by adjusting the position of the auger guide wheels 48, 49 relative to the housing 40. With the auger depth properly set, it will be seen that the auger 39 will remove a predetermined shallow layer of soil as the machine is moved in a forward direction and direct that soil upwardly into the auger chamber 44.

In further carrying out the invention, contaminated soil directed upwardly into the central chamber 44 of the auger housing 40 during the soil removal operation is pneumatically transferred to the soil separating and first bagging station 19 where the airborne soil is separated from the pneumatic flow stream, and then bagged and discharged from the machine for easy disposal from the site. More particularly, the soil separating and first bagging station 19 includes a cyclone separator 59 connected to the auger housing 44 by a conduit 60 for pneumatically receiving airborne soil and for separating the soil from the pneumatic air stream. For pneumatically directing air from the auger chamber 44 to the cyclone separator 59, a vacuum blower 61 is provided on the main frame 22 The vacuum blower 61, as will become apparent, is operable for creating a vacuum generated air flow from the auger chamber 44 through the cyclone separator 59, and in turn through a filter and second bagging station 12, and then through the final filter station 21.

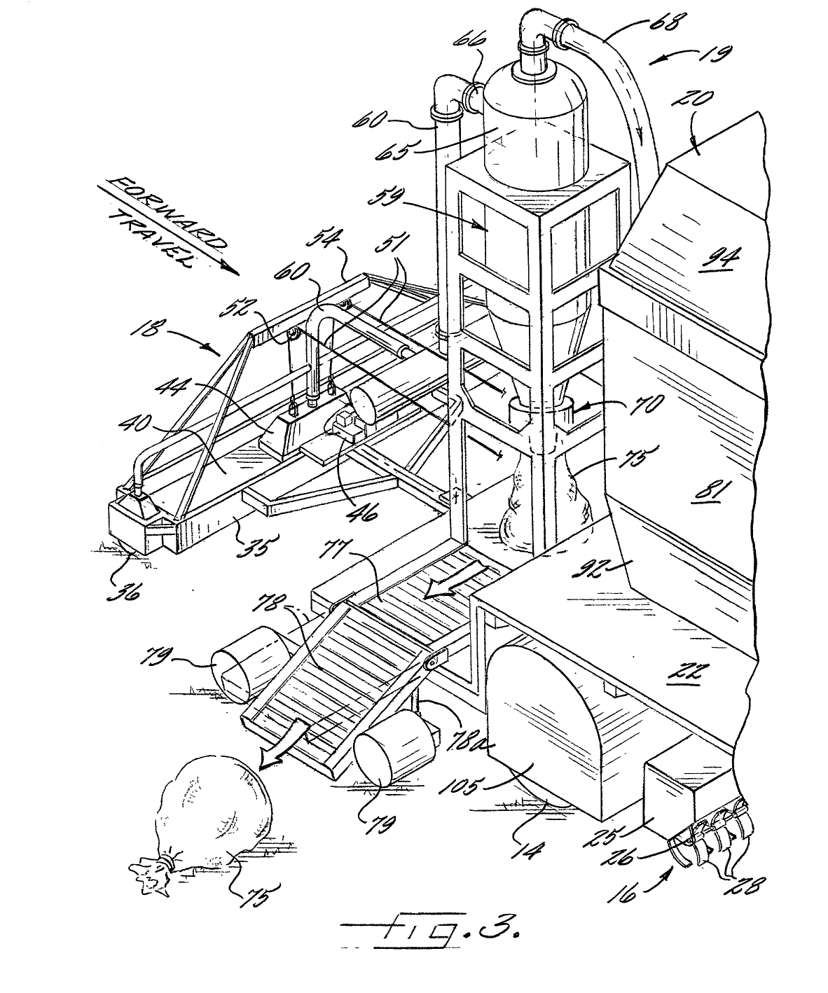

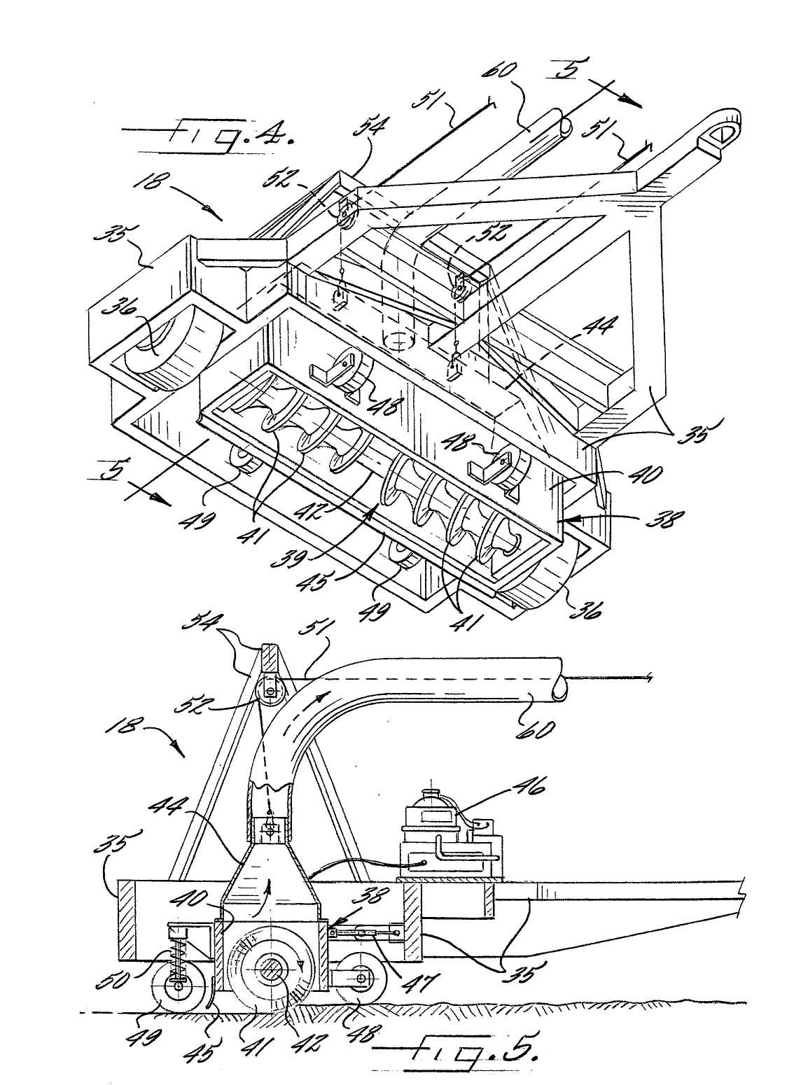

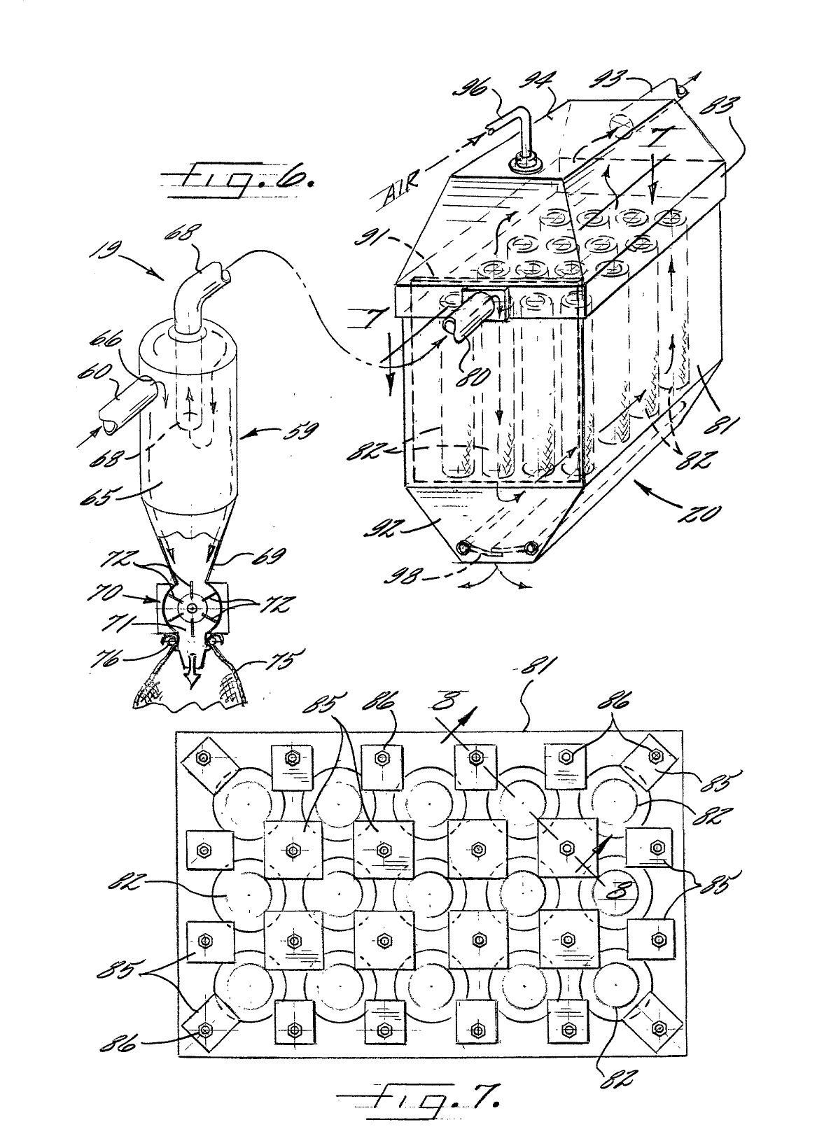

The cyclone separator 59, as best depicted in FIGS. 3 and 6, comprises a cylindrical housing 65 having a tangentially entering inlet 66 adjacent an upper end thereof and an outlet conduit 68 extending coaxially from the upper end. The outlet conduit 68 extends a substantial length downwardly into the cylindrical housing 65, in this case, about half the length of the cylindrical housing 65. Particle laden air tangentially directed into the cyclone separator 59 strikes the inner sides of the cylindrical housing 65 under the influence of centrifugal force as the air is forcibly directed around the depending outlet conduit 68 causing a substantial portion of the solid particles, and nearly all of the larger relatively heavier particles, to drop downwardly into an inwardly tapered conical discharge section 69 of the housing 65.

For enabling the controlled removal of solid particles accumulating in the bottom of the cyclone separator 59 without disrupting internal air pressure and flow, an air lock 70 is rotatably supported within a cylindrical outlet 71 of the cyclone separator 59. The air lock 70, which is rotatably driven by a respective hydraulic drive for the station, includes flexible radial blades 72 which define pockets for carrying the accumulated solids and which are successfully forced into sealing engagement with the cylindrical outlet 70. Hence, as the blades 72 rotate through the discharge opening, they maintain a sealed condition in the cyclone separator 59, while carrying discrete amounts of the accumulated solids through the outlet for discharge therefrom.

For containing solid material discharged from the cyclone separator 59, in this instance, bags 75 are removably secured to the bottom of the cyclone separator 59 by a releasable clamp 76. When each bag 75 is filled, the operator can unclamp the bag, tie the top, and clamp a new bag into position for continued operation. The filled bag 75 may be pushed along a roller conveyor 77 to a pivotal unloading ramp 78, supported by appropriate shock absorbers 78a (FIG. 2),which permit downwardly pivotal movement of the ramp 78 under the weight of the filled bag to effect gradual lowering of the bag to ground level, without rupturing of the bag 75. Upon unloading of the bag 75, the shock absorbers raise the ramp 78 to a horizontal position, for receiving the next bag, while not impeding continued forward operation of the machine. Rollers 79 may be provided on forward and rearward sides of the ramp 78 to prevent the ramp from striking or engaging the ground.

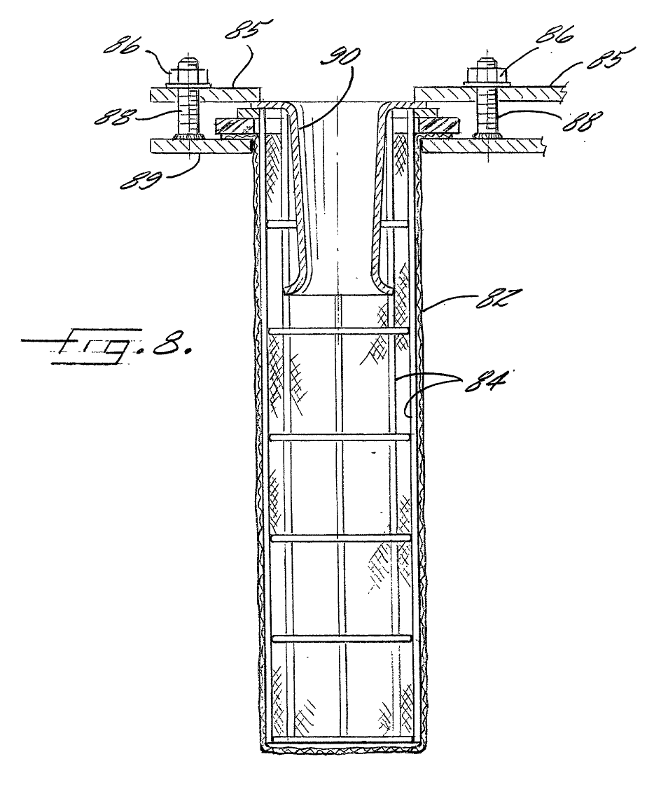

Air flow with remaining relatively fine solid particles will enter the lower end of the cyclone separator discharge conduit 68 for direction through an inlet conduit 80 to the filter and second bagging station 20 The filter and second bagging station 20 in this case has a rectangular housing 81, with a removable cover 83, to which the inlet conduit 80 communicates at an upper end. The housing 81 supports a plurality of vertically disposed filter bags 82, which each are removably positioned about an appropriate cylindrical configured wire cage 84, as best depicted in FIGS. 6-8. Each wire cage 84 is removably secured within the rectangular housing 81 by a plurality of rectangular hold down plates 85. Upon release of the hold down plates 85, by removal of nuts 86 from upstanding ends of studs 88 fixed to a frame plate 89, the cage 84 may be removed from the housing 81 to enable the bag to be positioned about the cage 84. The cage 84 and bag 82 are then repositioned within the housing, together with a central venturi tube 90, and the assembly is clamped in position by again securing the hold down plates 85. Each filter bag 82 may be of a conventional type, comprising an air pervious cloth material or the like which permits passage of air, while filtering solid particles from the air flow stream.

Particle laden air entering the housing 81 from the inlet 80 will strike a deflection plate 91 supported in forwardly spaced relation to the inlet 80 and extending downwardly from the upper end of the housing 81 to a level corresponding to the lower ends of the bags 84. Air will be deflected downwardly and proceed under the deflection plate 91, whereupon some of the solid particles in the flow station will fall into a downwardly and inwardly tapered collection hopper 92 on the underside of the rectangular housing 81.

The particle-laden air will then proceed through the multiplicity of filter bags 82, whereby a substantial portion of the remaining airborne particles are filtered out of the air stream by the filter bags 82, as the air travels through the air bags into a discharge plenum 94 defined by the cover 83 for direction through a conduit 93 to the final filter station 21. Some of the particulate matter filtered out of the air stream by the filter bags 82 will fall to the bottom of the collection hopper, while other of the removed particles will accumulate about the outer perimeter of the filter bags.

For periodically removing accumulated particles from the exterior of the bags 82, an appropriate air pump 95 (FIG. 1) mounted adjacent of the housing 81 is periodically actuated to direct bursts of pressurized air into plenum 94, via an inlet conduit 96, through the venturi tubes 90 into and through the filter bags 82 causing the accumulated particles to dislodge from the air bags and fall into a collection hopper 92. The collection hopper 92 has a downwardly and inwardly tapered configuration with a discharge opening closed by a knife valve 98. Periodically, the knife valve 98 may be opened to permit discharge of the accumulated material into appropriate disposal bags. Alternatively, the collection hopper 92 may be unloaded into an appropriate closed auger that communicates from the hopper 92 to the cyclone separator where the material can be reintroduced back into the system, thereby eliminating the necessity for periodically emptying the hopper into additional disposable bags.

Air exiting the filter and second bagging station 20 proceeds via the conduit 93 into an inlet of the final filter station 21, which comprises a plurality of stacked HEPA filters 99 of a known type, effective for filtering and removing remaining fine particles, such that air exiting the final filter station is 99.9% free of airborne particles. The exiting air stream in this instance communicates through a clean air chute 100, having conventional sound muffling baffles for exit into the atmosphere from the upper end.

In operation of the machine 10, it will be seen that as the machine is powered in a forward direction by the cab unit 11, the derocker station 16 will initially engage, remove and discard to the side of the machine rocks and vegetation while soil dislodged from the rocks and vegetation is allowed to fall through the screen conveyor 30 for subsequent processing by the machine. The scarfing unit 18 which trails the derocking station 16 will engage and remove a predetermined relatively shallow layer of soil, such as about one to three inches in depth, while closely following the contour of the ground, and direct the removed soil upwardly into the overhead chamber 44 of the scarfing unit 11 for pneumatic transfer, under operation of the blower 61, to the soil separation and first bagging station 19. The cyclone separator 59 at that station will thereupon separate and remove from the air stream a substantial portion of the solids, including nearly all of the larger sized solids, which can be discharged into bags 75 that are discarded from the machine as it proceeds, for subsequent easy pick up and transport to a suitable decontamination facility. Air and remaining fine particles discharging from the cyclone separator outlet 68 are directed to the filter and second bagging station 20 where additional solid particulate matter is removed from the air stream by action of the baffle plate 91 and bag filters 82. The removed solids again are accumulated in a hopper 92 of that unit for discharge into disposable bags. Air exiting the filter and second bagging station 20 communicates through conduit 93 to the final filter station 21 which removes nearly all remaining fine particles, prior to discharge to the atmosphere. It will be seen that the machine can be operated on a substantially continuous basis and because the scarfing unit 38 removes a predetermined, relatively shallow depth layer of surface soil during passage of the machine, the contour of the land is substantially unaffected and underlying uncontaminated soil is untainted during the soil removal operation. To further ensure against excessive removal of soil, tests for radioactivity or other contamination may be made during operation of the machine, and the machine may be redirected over the contaminated area until the removed soil is free of contaminants.

In keeping with the invention, to further guard against the discharge of contaminated dust into the environment and the cross contamination of surrounding areas by dust that may be directed into the air by the balloon wheels 13, 14 of the cab unit 11 and the soil removal and processing unit 12, the balloon wheels 13, 14 each are enclosed by a respective downwardly opening fender-like housing 105 having a lower perimeter in close proximity to the surface of the ground for defining a substantially enclosed vacuum chamber about the tire. Each chamber in turn is coupled via a vacuum line 106 to the cyclone separator 59. Preferably the vacuum lines 106 for the tire chambers on each side of the machine are coupled to a respective common manifold, which in turn is coupled to the cyclone separator 59. It will be seen that a vacuum air flow through the manifold lines 106, which may be generated by the vacuum blower 61, will draw airborne dust and dirt generated by movement of the balloon tires to the cyclone separator 59 where the dust is separated from the air flow stream and subsequently finally filtered simultaneously with the soil removal operation. Hence, harmful discharge to the environment is prevented.

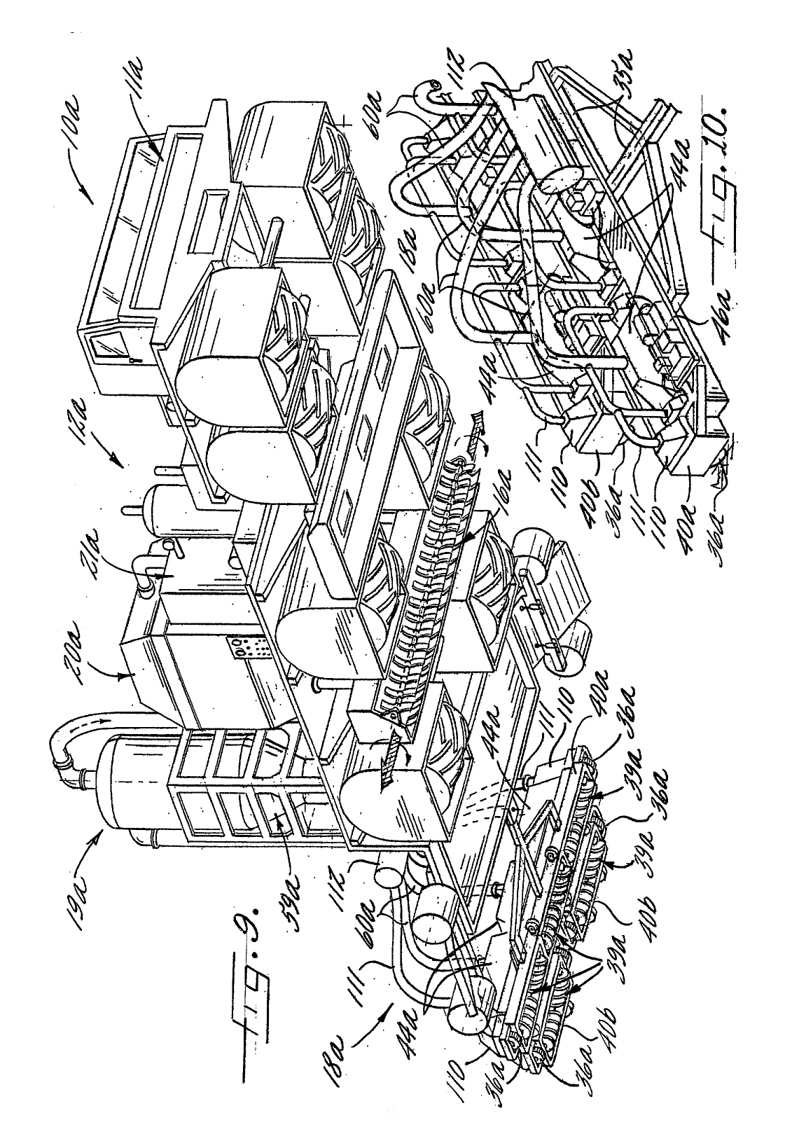

Referring now more particularly to FIGS. 9 and 10 of the drawings, there is shown a soil removal machine, similar to that described above, but with an alternative embodiment of soil removal station 18a, wherein items similar to those described above have given similar reference numerals with the distinguishing suffix a added. The soil removal station 18a in this instance includes a plurality of independently supported, floating augers 39a which each are driven by hydraulic drives 46a and pneumatically coupled via conduits 60a to the cyclone separator 59a of the soil separating and first bagging station 19a. The soil removal station 18a has a frame 35a supported by wheels 36a for towing movement in trailing relation behind the soil separation and first bagging station 19a. The frame 35a in this instance supports two rows of floating augers 39a for relative movement with respect to the frame, which enable the soil removing station to encompass a wider soil removing path while still closely following the contour of the terrain. In the illustrated embodiment, three augers 39a are disposed in a first row in side-by-side relation to each other, and two augers are disposed in side-by-side relation in a rearward row. The rearward augers are arranged so as to encompass the lateral spacing between the augers of the front row, thereby ensuring complete processing of a relatively wide area during each passage of the machine.

The augers of the first row in this instance have a common housing 40a and the augers of the second row have individual housings 40b. The auger housings 40a, 40b each are supported for rolling movement by a respective pairs of wheels 36a mounted adjacent opposite axial ends. Similar to the previous embodiment, during operation of the machine, each auger unit will remove a predetermined shallow depth of surface soil and direct it upwardly into a respective overhead chamber for pneumatic communication to the cyclone separator 59a of the soil removal and first bagging station 19a.

As a further feature of this embodiment of the invention, the individual housings 40a, 40b (FIG. 10) define downwardly opening chambers 110 about the support wheels 36a for the soil removal station 18a which each are coupled by a respective vacuum conduit 111 of the auger unit for communication with the discharge vacuum line 60a for central chambers 44a of the auger units via vacuum manifold 112. Hence, as the machine is moved in its forward operating direction, dust and dirt directed upwardly by the wheels 36a also are drawn by a vacuum generated air flow into the flow path of the soil removed by the auger for common direction to the cyclone separator 59a.

From the foregoing, it will be seen that a contaminated soil removal machine is provided for more efficiently removing contaminated surface soil for disposal and/or decontamination from large contaminated areas, such as desert nuclear test sites. The machine and its method of operation can be used without adversely affecting the contour of the land and eliminates unnecessary soil removal, typical of the prior art, and the tainting of previously uncontaminated soil. The machine further provides a relatively simple and effective means for containing the removed contaminated soil for easy transport from the site for decontamination.

What is claimed is:

1. A contaminated soil-removal machine comprising:
a power unit for moving the machine along a path of travel on a site having a contaminated surface soil;
a scarfing unit for engaging and dislodging an upper layer of soil as the machine is moved along the path of travel and directing the removed soil airborne; and
a soil separation unit for receiving an air stream of soil removed by said scarfing unit and separating the soil from the air stream for containment and removal from the site.

2. The machine of claim 1 in which said scarfing unit includes a helical blade for engaging a predetermined depth of surface soil, laterally moving the soil, and then directing the soil airborne.

3. The machine of claim 1 in which said scarfing unit includes a downwardly opening housing having an upper chamber, an auger disposed within said housing, said auger having a rotary driven shaft with a scarfing blade operable upon rotation of the shaft for engaging a predetermined layer of soil and directing the soil upwardly into said chamber.

4. The machine of claim 3 including a blower for causing the soil directed upwardly into said chamber to be pneumatically transferred to said soil separation unit.

5. The machine of claim 3 in which said scarfing unit is part of a soil separation station that includes a frame that is moveable with said power unit, and said scarfing unit housing being mounted for relative vertical movement with respect to said frame to accommodate variations in terrain of the site over which the machine travels.

6. The machine of claim 5 in which said auger has scarfing blades in the form of oppositely directed auger blades at opposite ends of a common auger shaft which extend below the lower perimeter of said housing, said auger blades being operable upon rotation of the shaft to engage a predetermined depth of soil, laterally move the soil inwardly from opposite ends of the auger to a central location of the housing, and then impel the soil upwardly into said chamber.

7. The machine of claim 5 in which said auger housing is supported for relative pivotal movement with respect to said frame.

8. The machine of claim 5 in which said auger housing is supported by rearward and forward guide wheels and is connected to said housing for relative pivotal movement to permit limited vertical movement of said auger.

9. The machine of claim 8 including springs for biasing at least some of the auger housing support wheels in a downward direction.

10. The machine of claim 3 in which said auger housing is selectively vertically positionable relative to said frame for establishing the depth of the layer of soil removed by said scarfing unit.

11. The soil removal machine of claim 1 including a plurality of said scarfing units each operable for engaging and dislodging an upper layer of surface soil as the machine is moved along the path of travel and directing the dislodged soil airborne, and said soil separation unit is operable for receiving the airborne soil from each of the scarfing units.

12. The machine of claim 11 in which said scarfing units are disposed in lateral side-by-side relation to each other.

13. The machine of claim 11 in which some of said scarfing units are arranged in side-by-side relation in a first row, and other of said scarfing units are arranged in lateral side-by-side relation to each other in a second row behind said first row.

14. The machine of claim 1 in which said soil separation unit includes a cyclone separator having a tangentially disposed inlet for receiving the airborne stream of soil removed by said scarfing unit and separating solids from the air stream by centrifugal forces acting to impinge the solids against an inner cylindrical wall of the cyclone separator.

15. The machine of claim 14 in which said cyclone separator has a lower discharge section for receiving solids separated from the air stream, said discharge section having an outlet for permitting the discharge of accumulated separated soil from the discharge section into bags secured thereto.

16. The machine of claim 15 in which said discharge section includes a rotary air lock having a plurality of flexible radial blades which define pockets for successively carrying and directing discrete amounts of removed solids into bags secured to the discharge section.

17. The machine of claim 15 including a conveyor for receiving bags of solid soil discharged from said cyclone separator and for directing the bags onto the ground as the machine is moving along the path of travel.

18. The machine of claim 17 in which said conveyor includes a pivotal unloading ramp that pivots downwardly under the weight of the bags to permit gradual lowering of the bag onto ground as the machine is moving along the path of travel.

19. The machine of claim 14 in which said cyclone separator has an axial outlet in an upper end thereof through which air and any remaining solid particulate matter remaining in the air stream exits the cyclone separator, a filter station having an inlet coupled to said cyclone separator outlet for receiving the air stream and remaining particulate matter and filtering particulate matter from the air stream.

20. The machine of claim 19 in which said filter station includes a housing having an inlet and a discharge plenum, and a plurality of cylindrical filters disposed within said housing for removing particulate matter from the air stream as it is directed from said filter station inlet to said discharge plenum.

21. The machine of claim 20 in which said housing has a lower discharge section into which removed solid particulate matter may accumulate, said discharge section having a selectively operable closure member for permitting removal and containment of solid particulate matter accumulated in said discharge section.

22. The machine of claim 21 including a deflector plate mounted in forwardly spaced relation to said filter station inlet against which an entering air stream impinges for directing solid particulate matter downwardly to said discharge section.

23. The machine of claim 22 in which said deflector plate extends downwardly the length of said cylindrical filters.

24. The machine of claim 20 in which said cylindrical filters are bags, said housing having a plurality of wire cages over which said bags are positionable and secured.

25. The machine of claim 20 including a pressurized air inlet communicating with said plenum through which pressurized air may be directed into said cylindrical filters for dislodging any filtered soil adhering to the exterior of said filters.

26. The machine of claim 20 in which said filter housing plenum has a discharge outlet communicating with a final filter station, said final filter station including a plurality of HEPA filters for removing substantially all remaining particulate solid material from the air stream prior to discharge to the atmosphere.

27. The machine of claim 1 including a rock and vegetation removal station disposed forwardly of said scarfing unit for removing soil and rocks from the surface of the ground along the path of travel of the machine prior to engagement of the soil by the scarfing unit.

28. The machine of claim 27 in which said rock and vegetation removal station includes a rotary driven pronged shaft extending transversely along the width of the machine and having curved fingers for engaging the ground as an incident to rotation of the shaft to dislodge, remove, and carry upwardly vegetation and rocks from the surface of the ground.

29. The machine of claim 28 including a conveyor disposed in parallel relation to said pronged shaft for receiving vegetation and rocks removed by said fingers and transporting and directing the removed vegetation and rocks to a side of the machine.

30. The machine of claim 29 in which said conveyor is selectively movable in opposite directions for directing removed vegetation and rocks to a selected side of the machine.

31. The machine of claim 29 in which said conveyor is in the form of a movable screen for receiving and transporting removed vegetation and rocks while allowing dislodged soil to fall through the screen for processing by the machine.

32. The machine of claim 1 in which said soil removal unit has balloon all-terrain tires, said tires each having a respective downwardly opening fender-like housing having a lower perimeter in close proximity to the surface of the ground for defining a substantially enclosed chamber about the tire, and each said chamber being coupled by a vacuum line to said cyclone separator such that dust and soil directed into the air by the tire is directed to the soil separation station.

33. A contaminated soil removal machine comprising:
a soil removal and processing unit adapted for movement along a path of travel on a site having contaminated surface soil, said soil removal and processing unit including a scarfing unit for engaging and dislodging an upper layer of soil as the machine is moved along the path of travel and directing the removed soil airborne; and a soil separation unit for receiving an air stream of soil removed by said scarfing unit and separating the soil from the air stream for containment and removal from the site.

34. The machine of claim 33 in which said soil removal and processing unit includes a blower for pneumatically directing removed soil from said scarfing unit to said soil separation unit, and a power unit for operating said blower and scarfing unit.

35. The machine of claim 34 in which said scarfing unit includes a downwardly opening housing having an upper chamber, an auger disposed within said housing, said auger having a rotary driven shaft with a scarfing blade operable upon rotation of the shaft for engaging a predetermined layer of soil and directing the soil upwardly into said chamber, and said blower is operable for causing soil directed upwardly into said chamber to be pneumatically transferred to said soil separation unit.

36. The machine of claim 35 in which said scarfing unit is part of a soil separation station that includes a frame that is moveable with said power unit, and said scarfing unit housing being mounted for relative vertical movement with respect to said frame to accommodate variations in terrain of the site over which the machine travels.

37. The machine of claim 36 in which said soil separation unit includes a cyclone separator having a tangentially disposed inlet for receiving the airborne stream of soil removed by said scarfing unit and separating solids from the air stream by centrifugal forces acting to impinge the solids against an inner cylindrical wall of the cyclone separator.

38. The machine of claim 37 in which said cyclone separator has an axial outlet in an upper end thereof through which air and any remaining solid particulate matter remaining in the air stream exits the cyclone separator, a filter station having an inlet coupled to said cyclone separator outlet for receiving the air stream and remaining particulate matter and filtering particulate matter from the air stream, said filter station including a housing having an inlet and a discharge plenum, and a plurality of filter bags disposed within said housing for removing particulate matter from the air stream as it is directed from said filter station inlet to said discharge plenum.

39. The machine of claim 1 in which said soil removal and processing unit includes a rock and vegetation removal station disposed forwardly of said scarfing unit for removing soil and rocks from the surface of the ground along the path of travel of the machine prior to engagement of the soil by the scarfing unit.

40. A method of removing contaminated surface soil comprising:
removing a predetermined depth of the surface soil on a continuous basis, directing the removed soil airborne into a chamber substantially enclosed from the outside environment, pneumatically directing the removed airborne surface soil in an air stream to a soil removal station, and separating soil from the air stream at the soil removal station.

41. The method of claim 40 including containing soil separated from the air stream at the soil removal station.

42. The method of claim 40 including containing soil separated from the air stream at the soil removal station by directing the separated soil into containment bags.

43. The method of claim 40 including removing and directing the predetermined depth of surface soil with engaging the surface soil by a rotatably driven helical scarfing blade.

44. The method of claim 40 including continuously engaging and removing rocks and vegetation from the surface soil prior to removing said predetermined depth of surface soil.

45. The method of claim 40 including removing soil from said air stream at said soil removal station by forcefully directing the air stream circumferentially within a cyclone separator.

46. The method of claim 40 including following removal of soil at said soil removal station, directing the air stream and any remaining solid particulate matter to a further soil removal station in which soil is filtered from the air stream prior to discharge to the atmosphere.

47. The method of claim 40 including testing soil separated from the air stream at the soil removal station, and based upon the results of such tests, removing a further predetermined depth of surface soil.
